(19) United States
(12) Patent Application Publication
(10) Pub. No.: US 2013/0129120 A1
(43) Pub. Date: May 23, 2013

(54) Speaker

(71) Applicant: Ting-Pang Chen, Taipei (TW)

(72) Inventor: Ting-Pang Chen, Taipei (TW)

(21) Appl. No.: 13/373,633

(22) Filed: Nov. 22, 2011

(51) Int. Cl. H04R 1/02

(52) U.S. Cl. 381/189

(57) ABSTRACT

A speaker has a body, a first packing ring and a fastening collar. The body includes a frame and sound components. The frame has a cover portion and an extension portion. A diameter of the cover portion is larger than a diameter of the extension portion. The sound components are mounted in the frame. The first packing ring is mounted around the extension portion of the body. The fastening collar is fastened around the extension portion of the body and watertightly abuts the first packing ring. Therefore, the speaker can be easily and quickly installed by mounting the first packing ring and the fastening collar around the body in sequence. Besides, the speaker can have a smooth appearance because no fixed structure on the cover frame is required.

### BACKGROUND OF THE INVENTION

1. Field of the Invention

The present invention relates to a speaker, and more particularly to a speaker that is smooth in appearance and may be easily and quickly installed.

2. Description of the Prior Arts

A speaker is an electroacoustic transducer that converts audio signals into sound. With reference to FIG. 5, a conventional speaker comprises a body 50 including a frame and sound components. The frame has a cover portion 51 and an extension portion 52. The cover portion 51 has multiple fastening holes 511 formed therein and arranged around a circumference thereof. A diameter of the cover portion 51 is larger than a diameter of the extension portion 52. The sound components are mounted in the frame and include a diaphragm, a voice coil, a permanent magnet and so on. As alternating current flows through the voice coil, a variable magnetic field is created to interact with the fixed magnetic field in the speaker. Consequently, the diaphragm vibrates and that causes sound to be produced.

With reference to FIG. 6, to install the speaker, the extension portion 52 of the body 50 is mounted through a mounting hole 61 of a housing 60 of a device to make the cover portion 51 of the body 50 watertightly abut a side surface of the housing 60. Multiple screws 70 are then respectively screwed into the fastening holes 511 of the cover portion 51 and housing 60 to fasten the speaker on the housing 60. However, fastening the speaker on the housing 60 by screws 70 requires a long processing time and thus lowers productivity. Besides, the fastening holes 511 formed through the cover portion 51 aesthetically damages the appearance of the speaker.

Further, when the speaker is installed in a device receiving water, the cover portion 51 of the body 50 is mounted in the housing 60 and the extension portion 52 of the body 50 protrudes out of the housing 60. To prevent water leakage, a silicone adhesive must be applied between the body 50 and the housing 60. However, applying the silicone adhesive also requires a long processing time and the silicone adhesive will easily lose its sealing capability due to aging.

To overcome the shortcomings, the present invention provides a speaker to mitigate or obviate the aforementioned problems.

### SUMMARY OF THE INVENTION

The main object of the present invention is to provide a speaker that is smooth in appearance and may be easily and quickly installed.

To achieve the foregoing objective, the speaker in accordance with the present invention comprises a body, a first packing ring and a fastening collar. The body includes a frame and sound components. The frame has a cover portion and an extension portion. A diameter of the cover portion is larger than a diameter of the extension portion. The sound components are mounted in the frame. The first packing ring is mounted around the extension portion of the body. The fastening collar is fastened around the extension portion of the body and watertightly abuts the first packing ring. Therefore, the speaker can be easily and quickly installed by mounting the first packing ring and the fastening collar around the body in sequence. Besides, the speaker can have a smooth appearance because no fixed structure on the cover frame is required.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a speaker in accordance with the present invention;

FIG. 2 is an exploded perspective view of the speaker in FIG. 1;

FIG. 3 is an operational side view of the speaker in FIG. 1 showing that the speaker clamps a housing;

FIG. 4 is an operational side view of another embodiment of a speaker in accordance with the present invention showing that the speaker clamps a housing;

FIG. 5 is a perspective view of a conventional speaker in accordance with the prior art; and

FIG. 6 is an operational side view of the conventional speaker in FIG. 5 showing that the speaker is mounted to a housing by screws.

### DETAILED DESCRIPTION OF THE PREFERRED EMBODIMENTS

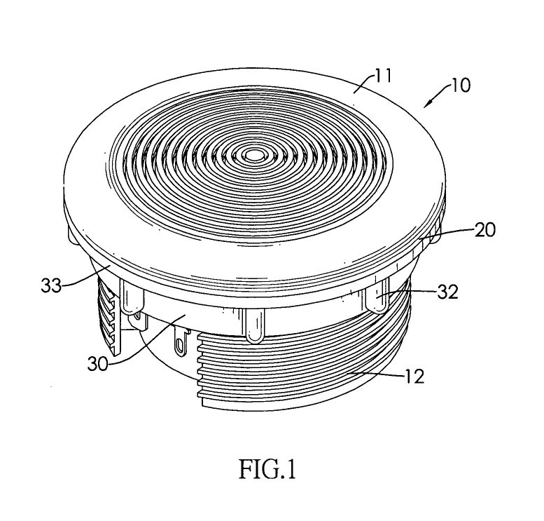

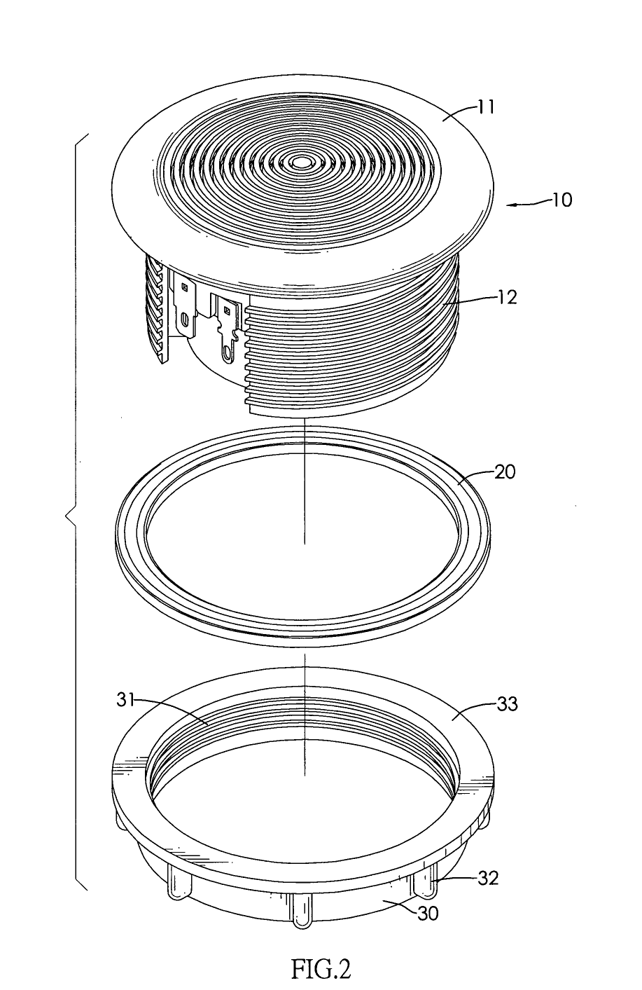

With reference to FIGS. 1 and 2, a speaker in accordance with the present invention comprises a body 10, a first packing ring 20 and a fastening collar 30.

The body 10 includes a frame and sound components. The frame has a cover portion 11 and an extension portion 12. A diameter of the cover portion 11 is larger than a diameter of the extension portion 12. The extension portion 12 has an external thread. The sound components are mounted in the frame and have a diaphragm, a voice coil, a permanent magnet and so on. The sound components are conventional and thus descriptions thereof will be omitted.

The first packing ring 20 may be made of resilient material such as rubber and is mounted around the extension portion 12 of the body 10.

The fastening collar 30 is fastened around the extension portion 12 of the body 10 and includes an annular sidewall, multiple ribs 32 and a flange 33. The annular sidewall has an internal thread 31 screwed onto the external thread of the extension portion 12 of the body 10. The ribs 32 are formed around and respectively protrude from an outer surface of the annular sidewall for convenient operation by the operator. The flange 33 is formed on a top end of the annular sidewall and watertightly abuts the first packing ring 20.

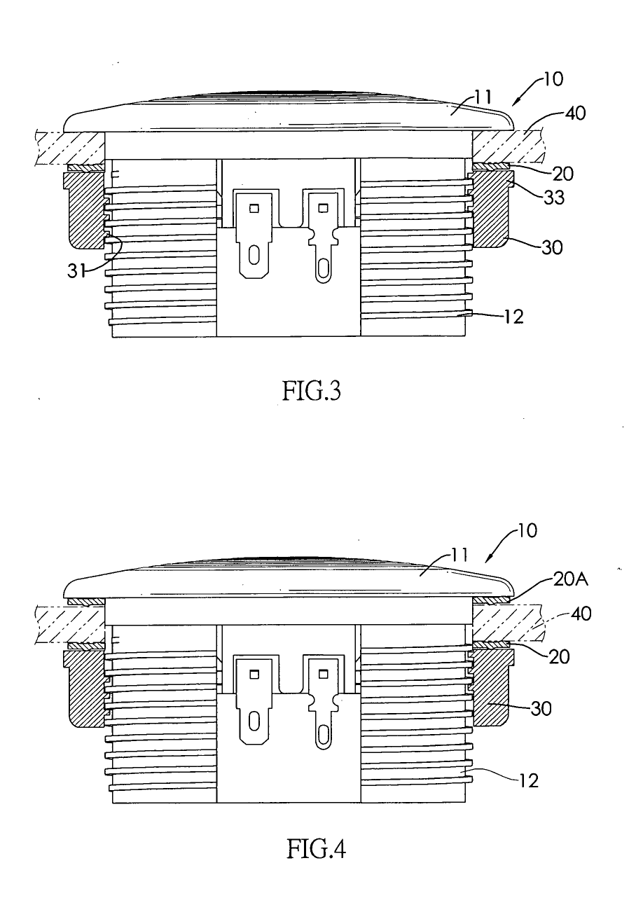

With reference to FIG. 3, to install the speaker in accordance with the present invention, the extension portion 12 of the body 10 is mounted through a mounting hole of a housing 40 from a side of the housing 40 to make the cover portion 11 of the body 10 watertightly abut a side surface of the housing 40. Then, from another side of the housing 40, the first packing ring 20 is mounted around the extension portion 12 of the body 10 and the fastening collar 30 is fastened around the extension portion 12 of the body 10 to make the flange 33 watertightly abut the first packing ring 20 and further to make the first packing ring 20 watertightly abut another side surface of the housing 40. Thus, the speaker can be easily and quickly fastened on the housing 40 without using screws and a silicone adhesive. Besides, the speaker can have a smooth appearance because no fixed structure on the cover frame is required.

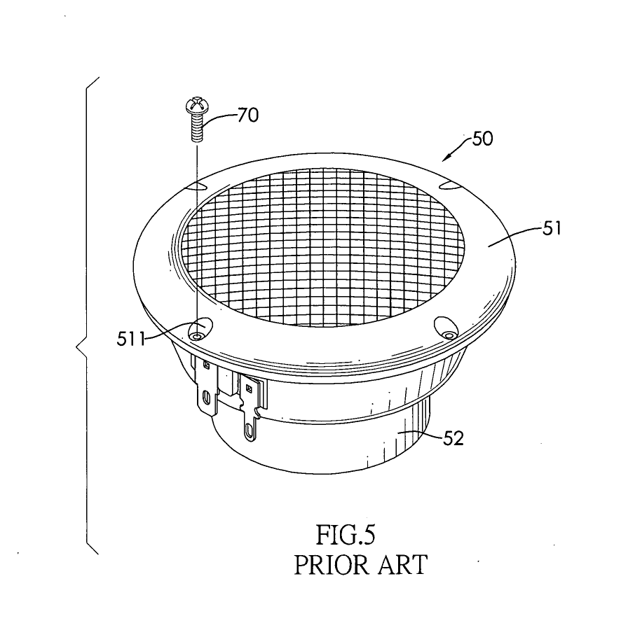

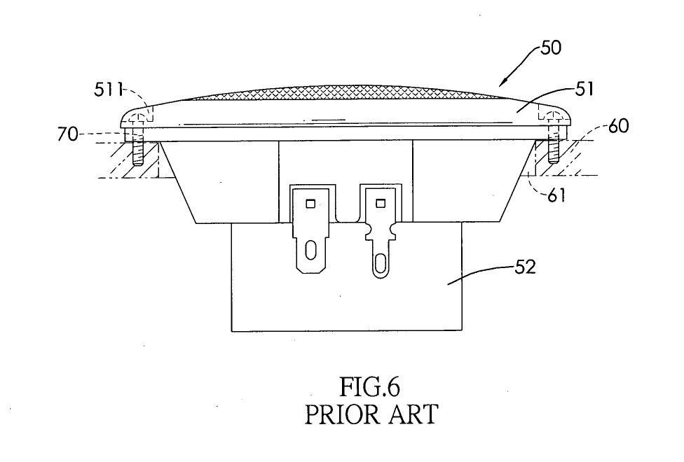

With reference to FIG. 4, in another embodiment, the speaker further comprises a second packing ring 20A that may be made of resilient material such as rubber and is mounted around the extension portion 12 of the body 10 for a better sealing effect. To install the speaker, the second packing ring 20A is mounted around the extension portion 12 of the body 10 first, then the extension portion 12 of the body 10 is mounted through a mounting hole of the housing 40 from a side of the housing 40 to make the second packing ring 20A watertightly abut a side surface of the housing 40. Finally, from another side of the housing 40, the first packing ring 20 and the fastening collar 30 are mounted around the extension portion 12 of the body 10 in sequence to fasten the speaker on the housing 40.

Even though numerous characteristics and advantages of the present invention have been set forth in the foregoing description, together with details of the structure and features of the invention, the disclosure is illustrative only. Changes may be made in the details, especially in matters of shape, size and arrangement of parts within the principles of the invention to the full extent indicated by the broad general meaning of the terms in which the appended claims are expressed.

What is claimed is:

1. A speaker comprising:
a body including
a frame having a cover portion and an extension portion and a diameter of the cover portion being larger than a diameter of the extension portion; and
sound components mounted in the frame;
a first packing ring mounted around the extension portion of the body; and
a fastening collar fastened around the extension portion of the body and watertightly abutting the first packing ring.

2. The speaker as claimed in claim 1, wherein
the extension portion of the body has an external thread; and
the fastening collar includes an annular sidewall having an internal thread screwed onto the external thread of the extension portion of the body.

3. The speaker as claimed in claim 1, wherein the fastening collar includes a flange and the fastening collar watertightly abuts the first packing ring by the flange.

4. The speaker as claimed in claim 2, wherein the fastening collar includes a flange formed on a top end of the annular sidewall and the fastening collar watertightly abuts the first packing ring by the flange.

5. The speaker as claimed in claim 1, wherein the fastening collar includes multiple ribs formed around and respectively protruding from an outer surface of the fastening collar.

6. The speaker as claimed in claim 2, wherein the fastening collar includes multiple ribs formed around and respectively protruding from an outer surface of the annular sidewall.

7. The speaker as claimed in claim 3, wherein the fastening collar includes multiple ribs formed around and respectively protruding from an outer surface of the fastening collar.

8. The speaker as claimed in claim 4, wherein the fastening collar includes multiple ribs formed around and respectively protruding from an outer surface of the annular sidewall.

9. The speaker as claimed in claim 1 further comprising a second packing ring mounted around the extension portion of the body and watertightly abutting the cover portion of the body.

10. The speaker as claimed in claim 2 further comprising a second packing ring mounted around the extension portion of the body and watertightly abutting the cover portion of the body.

11. The speaker as claimed in claim 3 further comprising a second packing ring mounted around the extension portion of the body and watertightly abutting the cover portion of the body.

12. The speaker as claimed in claim 4 further comprising a second packing ring mounted around the extension portion of the body and watertightly abutting the cover portion of the body.

13. The speaker as claimed in claim 5 further comprising a second packing ring mounted around the extension portion of the body and watertightly abutting the cover portion of the body.

14. The speaker as claimed in claim 6 further comprising a second packing ring mounted around the extension portion of the body and watertightly abutting the cover portion of the body.

15. The speaker as claimed in claim 7 further comprising a second packing ring mounted around the extension portion of the body and watertightly abutting the cover portion of the body.

16. The speaker as claimed in claim 8 further comprising a second packing ring mounted around the extension portion of the body and watertightly abutting the cover portion of the body.
